(19) United States
(12) Patent Application Publication
(10) Pub. No.: US 2025/0296465 A1
(43) Pub. Date: Sep. 25, 2025

(54) SYSTEM AND METHOD FOR ELECTRIC VEHICLE CHARGING AND LOAD MANAGEMENT

(71) Applicant: Eta Works LLC, Denver, CO (US)

(72) Inventor: Eric Daniel Smith, Denver, CO (US)

(21) Appl. No.: 19/087,341

(22) Filed: Mar. 21, 2025

Related U.S. Application Data
(60) Provisional application No. 63/568,139, filed on Mar. 21, 2024.

(51) Int. Cl. B60L 53/66; B60L 53/62; H02J 3/14; H02J 13/00

(52) U.S. Cl. CPC B60L 53/66; B60L 53/62; H02J 3/14; H02J 13/00002; H02J 13/00022

(57) ABSTRACT

A system and method for electric vehicle charging and load management is described. The system includes an interlock device for connection to an electric vehicle supply and an existing load. The interlock device is configured to: interrupt a control line of an existing load; interrupt a state line of the electric vehicle supply; and monitor the control and state lines for signals. In response to receiving concurrent activation signals for both the electric vehicle supply and the existing load, the interlock device transmits a signal to cease power delivery to the existing load. The interlock device then transmits a signal to activate the electric vehicle supply. The interlock device system and method therefore enables use of a single circuit by multiple loads while preventing simultaneous power delivery and thus circuit overload.

### CROSS REFERENCE TO RELATED APPLICATIONS

This application claims the benefit of the U.S. Provisional Application No. 63/568,139 filed on 21 Mar. 2024, which is incorporated in its entirety by this reference.

### TECHNICAL FIELD

This invention generally relates to the fields of electric vehicle charging and, more specifically, to a system of electric vehicle charging and load management of an existing load and method thereof.

### BRIEF DESCRIPTION OF FIGURES

FIG. 1 is a schematic representation of an integrated variation of the system;

FIG. 2 is a schematic representation of one variation of the system;

FIG. 3 is a schematic representation of a wireless variation of the system;

FIG. 4A is a flowchart representation of one variation of the method;

FIG. 4B is a continuation of the flowchart representation of the method of FIG. 4A;

FIG. 5A is a flowchart representation of one variation of the method; and

FIG. 5B is a continuation of the flowchart representation of the method of FIG. 5A.

### DETAILED DESCRIPTION DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

Generally, the term “include,” as utilized herein, can mean “comprise,” “consist of,” or “consist essentially of” and is not restricted to any one of the above interpretations throughout.

Generally, the term “a set of,” as utilized herein, refers to one or more of the subject objects. Additionally, the terms “first,” “second,” “third,” etc., as utilized herein, do not imply an order but simply identify multiple instances of a step or component unless an order or series is otherwise implied.

Generally, the term “approximately,” as utilized herein, indicates that a provided value may vary within some threshold, which, unless otherwise specified, is +5%.

Generally, the term “interlock device,” as utilized herein, indicates a device electrically connecting two or more loads to the same circuit, configured to allow only one load at a time to access power from the circuit.

Generally, the term “intercept,” as utilized herein, indicates the detection and inhibition of an electrical signal in its progress from a transmitter to a receiver.

Generally, the term “interrupt,” as utilized herein, indicates a physical connection (e.g., of an interrupter) between a transmitter and a receiver. An interrupter is configured to interrupt an electrical connection and then intercept the signal, thereby halting the signal in its propagation from transmitter to receiver.

### 1. System for Electric Vehicle Charging and Load Management

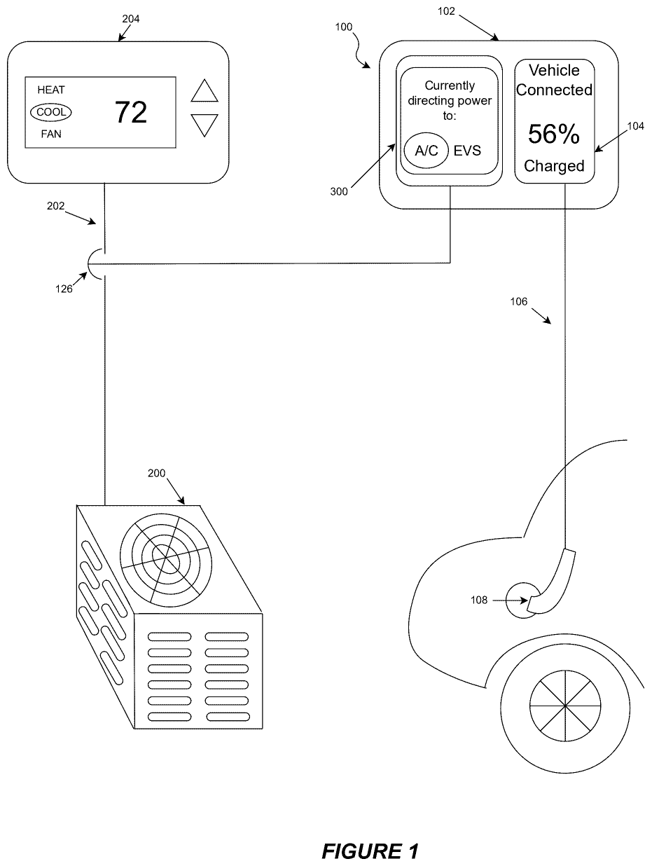

As shown in FIG. 1, a system for charging an electric vehicle includes: an electric vehicle supply and an interlock module. The electric vehicle supply includes: an electric vehicle supply controller comprising an engagement input; a charging interface comprising an engagement output; and a state line communicatively coupling the electric vehicle supply controller to the charging interface and configured to indicate engagement between the charging interface and the electric vehicle supply controller. The interlock device: interrupts an existing control line between a control output of a load controller of the existing load and a control input of the existing load; communicatively couples to the control input of the existing load; communicatively couples to the control output of the load controller of the existing load; interrupts the state line of the electric vehicle supply; communicatively couples to the engagement output of the charging interface; and communicatively couples to the engagement input of the electric vehicle supply controller. The interlock device is configured to, in response to receiving a first engagement signal via the charging interface at a first time and receiving a first activation signal directed to the existing load at a second time after the first time and concurrent with the first engagement signal: intercept the first activation signal; intercept the first engagement signal; and, in response to confirming a cessation in power delivered to the charging interface, transmit the first activation signal to the existing load.

### 2. Interlock Device for Electric Vehicle Charging and Load Management

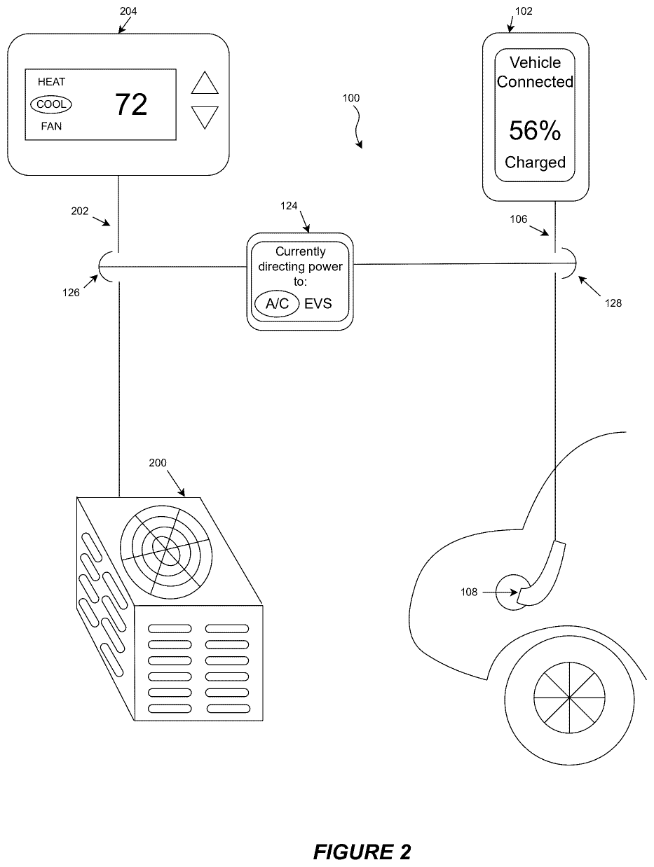

As shown in FIG. 2, the interlock device is an independent device separate from the electric vehicle supply. The interlock device: interrupts an existing control line between a control output of a load controller of an existing load and a control input of the existing load; communicatively couples to the control input of the existing load; communicatively couples to the control output of the load controller of the existing load; interrupts a state line of the electric vehicle supply, whereby the state line communicatively couples an electric vehicle supply to a charging interface configured to indicate engagement between the charging interface and the electric vehicle supply; communicatively couples to an engagement output of the charging interface; and communicatively couples to the engagement input of the electric vehicle supply. The interlock device is configured to, in response to receiving a first engagement signal via the charging interface at a first time and receiving a first activation signal directed to the existing load at a second time after the first time and concurrent with the first engagement signal: intercept the first activation signal; intercept the first engagement signal; and in response to confirming a cessation in power delivered to the charging interface, transmit the first activation signal to the existing load

### 3. Method for Electric Vehicle Charging and Load Management

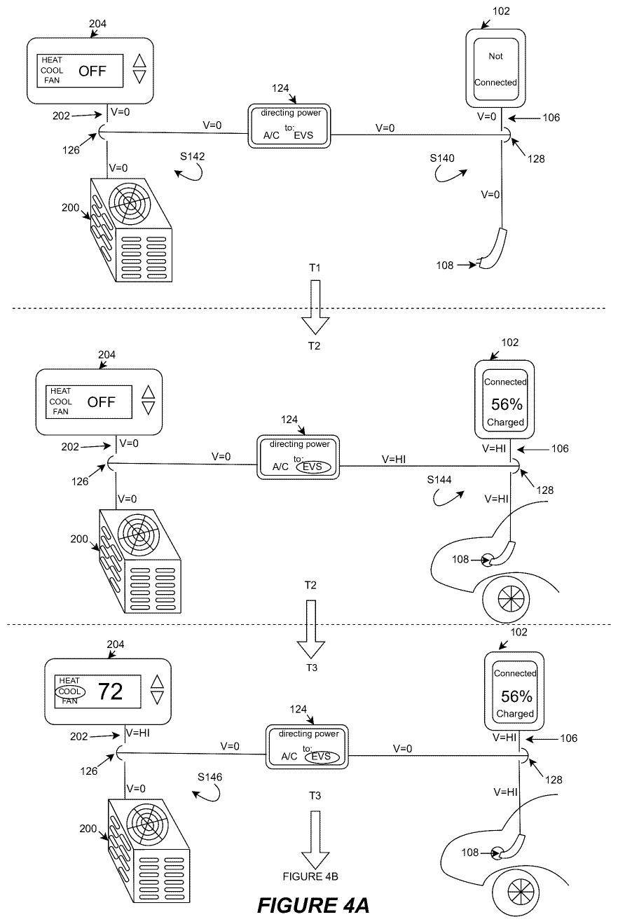

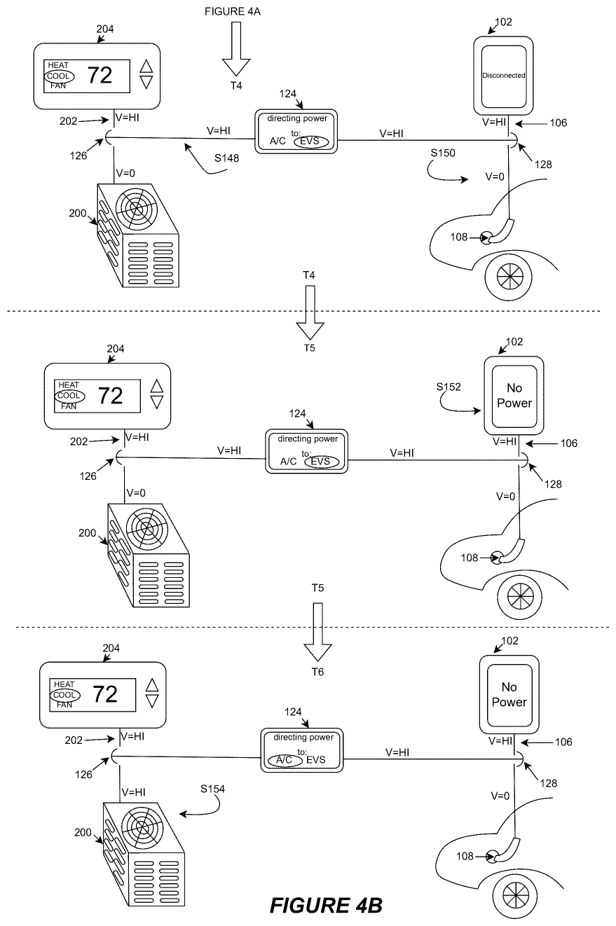

As shown in FIGS. 4A and 4B, a method S100 for charging an electric vehicle includes: monitoring a state line of an electric vehicle supply, the state line configured to transmit and receive engagement signals indicating electrical connection between an electric vehicle and the electric vehicle supply in Step S140; and monitoring a control line of an existing load, the control line configured to transmit and receive a set of binary control signals in Step S142. The method S100 additionally includes, in response to receiving a first engagement signal via the state line of the electric vehicle supply at a first time in Step S144 and receiving a first activation signal directed to the existing load via the control line at a second time after the first time and concurrent with the first engagement signal in Step S146: intercepting the first activation signal in Step S148; intercepting the first engagement signal in Step S150; and, in response to confirming a cessation in power delivered to the charging interface in Step S152, admitting the first activation signal to the existing load in Step S154.

### 4. Applications

Generally, installing an electric vehicle charger into a residential home may require complex and invasive electrical work, such as adding a new circuit to a breaker panel of the home to power the electric vehicle supply. To install a level 2 charger for an electric vehicle, typical installation requires the addition of a 240V circuit and breaker, resulting in potentially complex electrical work and, thus, expensive installation costs.

However, a system for charging an electric vehicle (hereinafter “the system 100”) including an interlock module or a distinct interlock device 124 can enable less invasive installation of an electric vehicle supply 102 to a building (e.g., a residential home or any other structure with an existing breaker panel) by interlocking the electric vehicle supply 102 to an existing circuit (e.g., a level-two compatible circuit)_of the building's breaker panel currently supplying power to an intermittently used load, such as an air conditioner or heat pump.

The system 100 includes a load interrupter configured to connect to a control line 202 of the existing load 200. The interlock device 124 includes an electric vehicle supply interrupter configured to connect to a state line 106 of the electric vehicle supply, in addition to the load interrupter described above. Each interrupter is configured to monitor signals on the control line 102 or state line 106 and intercept an activation signal (e.g., a signal to power on the air conditioner or indicating engagement between the charging interface 108 and an electric vehicle) on the control line 202 or state line 106. For example, if an electric vehicle is currently plugged into the electric vehicle supply 102 and charging, and a thermostat sends a signal to a compressor of the air conditioner to turn on, the load interrupter intercepts the signal sent by the thermostat before the signal is received by the compressor. The interlock device 124, or interlock module within the system 100, then triggers the electric vehicle supply 102 to stop charging the electric vehicle. Once the interlock device 124 or interlock module confirms a cessation of power delivery to the electric vehicle via the electric vehicle supply, the interlock device or interlock module admits the intercepted signal to the compressor of the air conditioner, allowing power to be delivered to the compressor for the compressor to activate. The interlock device or interlock module can therefore manage the loads of the electric vehicle supply 102 and the air conditioners to ensure that only one load (e.g., the air conditioner or the electric vehicle supply) is receiving power at a time. The interlock device or interlock module thereby prevents overloading of the circuit hosting both the air conditioner and the electric vehicle supply 102 by preventing simultaneous power demand by both loads.

The system 100 and interlock device 124 are configured to connect to low voltage and low current control line 202 of both the electric vehicle supply 102 and the existing load 200. As discussed in the above example, the system 100 and the interlock device 124 can connect to the control line 202 running between the thermostat and air conditioner compressor rather than the power line of the compressor. By connecting to a low voltage, low current line, the system 100 and the interlock device 124 ensure ease and safety of installation while maintaining low materials costs.

In one implementation, the system 100 integrates an interlock module within an electric vehicle supply 102 such that the system 100 can be installed directly on an existing circuit of the breaker panel. Alternatively, the interlock device 124 is a separate component configured for installation with many electric vehicle supplies 102 and existing loads 200.

In one implementation, the system 100 or interlock device 124 is configured to display or communicate with a remote user interface that provides a user input field for load prioritization. The system 100 or interlock device 124 can wirelessly communicate with an application on a mobile device of a user, the application configured to receive an input from a user prioritizing the existing load 200 or the electric vehicle supply 102. For example, a user can prioritize charging their vehicle over temperature control of their residence. In response to that user selection, the system 100 or interlock device 124 will not allow the air conditioner to activate until the electric vehicle reaches a target charge level to ensure fast and contiguous charging of the electric vehicle. Conversely, in response to the user selection of prioritization of the air conditioner, the system 100 interlock device 124 will interrupt and not admit an activation signal to the electric vehicle supply 102 while an electric vehicle is plugged in until the thermostat senses a target temperature or holds the residence at the target temperature for a target length of time.

### 5. Existing Load

The existing load 200 can include any intermittently powered home appliance or system (e.g., an air conditioner, an electric heater, a heat pump, a water heater, etc.). The existing load 200 can define any particular model or brand (e.g., unrelated to the system 100 or the interlock device 124) and be controlled by the system 100 or the interlock device 124 as long as a control line 202 of the existing load 200 is accessible for installation of the system 100 or interlock device 124.

The existing load 200 includes a control line 202 electrically connecting the existing load 200 to a load controller 204. The load controller 204 (e.g., a thermostat for an air conditioner or heat pump) transmits signals to the existing load 200 to activate and deactivate the existing load 200 based on sensed conditions. For example, in response to the load controller 204 detecting a temperature of an indoor space (e.g., via a temperature sensor located within the indoor space) above a target temperature, the thermostat transmits a signal via the control line 202 to the air conditioner to activate the compressor to begin cooling the indoor space.

In one implementation, the existing load is wired to an existing circuit of a breaker panel providing at least 240V and 15 amps.

In another implementation, the existing load 200 includes a set of control lines 202, each configured to transmit a binary control signal, the combination of which results in the selection of a particular mode of operation of the existing load 200 (e.g., a low and a high mode for air conditioner or a heating or cooling mode of a heat pump). The existing load can use any binary logic function to respond to control signals transmitted by the set of control lines.

### 6. Integrated System

In general, the system 100 enables the electrical vehicle supply 102 and the existing load 200 to share an existing circuit by switching which load (e.g., the existing load 200 or the electric vehicle supply 102) is drawing power from the existing circuit that the electric vehicle supply 102 and existing load 200 share. In one implementation, the system 100 defines an integrated system featuring an interlock module integrated within an electric vehicle supply controller of an electric vehicle supply, which specifically controls the interlock logic of the system 100.

### 6.1 Electric Vehicle Supply

In the variant shown in FIG. 1, the system 100 can include an electric vehicle supply 102 that provides the electrical interface and control for charging an electric vehicle. More specifically, the electric vehicle supply 102 includes: an electric vehicle supply controller 104 comprising an engagement input; a charging interface 108 comprising an engagement output; and a state line 106 communicatively coupling the electric vehicle supply controller 104 to the charging interface 108 and configured to indicate engagement between the charging interface 108 and the electric vehicle supply controller 104.

### 6.1.1 Charging Interface

In particular, the electric vehicle supply 102 can include a charging interface 108 compatible with a wide range of electric vehicle models via compliance with one or more charging standards. For example, the electric vehicle supply 102 can include connectors compliant with industry standards such as the SAE J1772 or CCS standards. The connectors can be designed to be durable to repeated engagement and disengagement, easy to connect and disconnect, and maintain a secure and stable connection during charging. Thus, the electric vehicle supply 102 can include a charging interface 108 adhering to electric vehicle charging standards, enabling compliant charging of electric vehicles by the electric vehicle supply 102.

The charging interface 108 can also monitor electrical parameters (e.g., voltage, current, power factor) of the electrical supply and control the transfer of electrical power from the electrical supply to the battery of the vehicle accordingly. Therefore, the charging interface 108 is configured to transmit a signal to the electric vehicle supply controller indicating proper connection of the charging interface to an electric vehicle.

### 6.1.2 State Line

The state line 106 defines an electrical communication line between the electric vehicle supply controller 104 and the charging interface 108. The state line 106 can transmit the engagement signal (e.g., the connection status) of the electric vehicle supply 102 to the electric vehicle in real-time. Generally, the state line 106 is configured to transmit a binary engagement signal indicating the presence or absence of a secure connection between the charging interface 108 and an electric vehicle. Thus, the state line 106 transmits an engagement signal indicating the engagement status (e.g., connected or disconnected) between the electric vehicle and the electric vehicle supply, thereby allowing the electric vehicle supply controller 104 to coordinate the start of the charging process and ensuring that power is supplied only when the charging interface 108 is correctly engaged with the electric vehicle.

### 6.1.3 Electric Vehicle Supply Controller

In one implementation, the electric vehicle supply 102 includes an electric vehicle supply controller 104 integrated within the electric vehicle supply 102 itself. Thus, the system 100 can include fewer separate components, which may reduce manufacturing costs and increase reliability. The integrated controller can control engagement and power delivery to the electric vehicle via direct communication with the charging interface 108 and the interlock module 300. In this implementation, the integrated controller includes sufficient processing power and memory and is configured with instructions effective to execute the method S100.

The electric vehicle supply controller 104 is configured to detect engagement of an electric vehicle at the charging interface 108, to initiate a charging session, and to enable power delivery only when a vehicle is engaged at the charging interface 108.

### 6.2 Interlock Module

The integrated system variation includes an interlock module 300 integrated within the electric vehicle supply controller. The interlock module includes logic, instruction executable by a processor, and/or physical hardware enabling the electric vehicle supply controller 104 to execute the method S100 for managing an electric vehicle supply and existing load connected to a single circuit.

### 6.2.1 Load Interrupter

Generally, the load interrupter 126 is an electrical connector for connection of the electric vehicle supply controller to the control line 202 of an existing load 200. The load interrupter 126 is configured to intercept a signal (e.g., halt the progress of a signal on the control line 202 and/or prevent the signal from reaching an intended receiver) and admit signals along the control line 202 in response to states of the interlock module. The load interrupter 126 includes a signal interception mechanism that is sensitive enough to intercept and process control signals in real-time, even when exposed to variable voltage or transient spikes.

In one implementation, the load interrupter 126 defines a clip including a latching mechanism such that the load interrupter 126 can permanently or transiently connect to the control line 202. The clip further defines interior electrical nodes configured to make electric contact with the control line 202. The load interrupter 126 further defines an electrical connector (e.g., a wire or cable) connecting the load interrupter 126 clip to an interlock module.

However, the integrated system featuring the interlock module of the electric vehicle supply controller lacks an electric vehicle supply interrupter, as the interlock module can directly access engagement signals processed by the electric vehicle supply controller.

### 7. Independent Interlock Device

In one implementation, the system 100 defines an independent interlock device 124 separate from the electric vehicle supply. The interlock device 124 electrically connects to the electric vehicle supply via an electric vehicle supply interrupter. The electric vehicle supply that the interlock device 124 connects to is similar to the electric vehicle supply described above but lacks the interlock module 300 integrated within the electric vehicle supply controller.

### 7.1 Interlock Device

Generally, the interlock device 124 is configured to control the power flow between the electric vehicle supply 102 and existing loads by intercepting control signals to prevent concurrent power delivery and, thus, circuit overloads. More specifically, the interlock device 124: interrupts an existing control line 202 between a control output of the existing load 200 and a control input of the existing load 200; communicatively couples to the control input of the existing load 200; communicatively couples to the control output of the load controller 204 of the existing load 200; interrupts the state line 106 of the electric vehicle supply; communicatively couples to the engagement output of the charging interface 108; and communicatively couples to the engagement input of the electric vehicle supply controller 104. The interlock device 124 is configured to, in response to receiving a first engagement signal via the charging interface 108 at a first time and receiving a first activation signal directed to the existing load 200 at a second time after the first time and concurrent with the first engagement signal: intercept the first activation signal; intercept the first engagement signal; and in response to confirming a cessation in power delivered to the charging interface 108, admit the first activation signal to the existing load 200.

Generally, the interlock device includes: a load interrupter 126; an electric vehicle supply interrupter 128; and a controller. The interlock device can also include real-time monitoring and response capabilities that can detect small changes in power state or signal integrity and respond immediately to changes in demand or supply conditions. Additionally, the interlock device 124 can include load coordination and management capabilities that enable the interlock device 124 to determine which load should be powered at a given time. Thus, the interlock device 124 can continuously monitor control signals from both the electric vehicle supply 102 and the existing load to prevent circuit overloads and optimize energy usage.

In one implementation, the interlock device 124 electrically connects the load interrupter as described above with reference to the integrated system.

In one implementation, the interlock device is contained within a durable enclosure that protects it from environmental hazards, such as dust, moisture, and temperature changes. The durable housing also protects internal components from electrical interference and physical impacts, includes ventilation to prevent overheating, and allows for access for maintenance, thereby prolonging the life of the interlock device and maintaining its performance.

### 7.2 Interlock Controller

The interlock device controller 130 functions as the central processing unit of the interlock device and is responsible for managing power distribution within the system 100 according to the method S100. The interlock device controller 130 monitors and manages signals from the load interrupter 126 and the electric vehicle supply interrupter 128 to ensure that power is supplied to only one load at a time, thereby preventing circuit overloads. The interlock device controller 130 is configured to process multiple signals at once in order to maintain reliable operation.

Additionally, the interlock device controller 130 manages dynamic distribution of power between the electric vehicle supply 102 and existing loads 200 (e.g., air conditioners, heat pumps) connected to the interlock device by monitoring the control line and the state line, such that only a single load is powered at a time.

### 7.3 Electric Vehicle Supply Interrupter

The electric vehicle supply interrupter 128 is configured to electrically connect to the state line 106 of the electric vehicle supply controller 104. The electric vehicle supply interrupter 128 executes a signal interception, as described in reference to the load interrupter, to intercept and manage engagement signals between the electric vehicle supply 102 and the charging interface 108. The electric vehicle supply interrupter 128 can detect signals in real-time and admit the signals to the controller of the interlock device to inform power distribution of the interlock device 124. The electric vehicle supply interrupter monitoring 128 device must be capable of withstanding the electrical properties (e.g., voltage, current) of the state line 106, function reliably in a typical home garage or outdoor charging station environment, consume minimal power, and include fail-safes to avoid false positives and signal interference. The electric vehicle supply interrupter 128 defines a similar structure to the load interrupter 126 and electrically connects to the interlock device controller 130.

### 8. Wireless Implementation

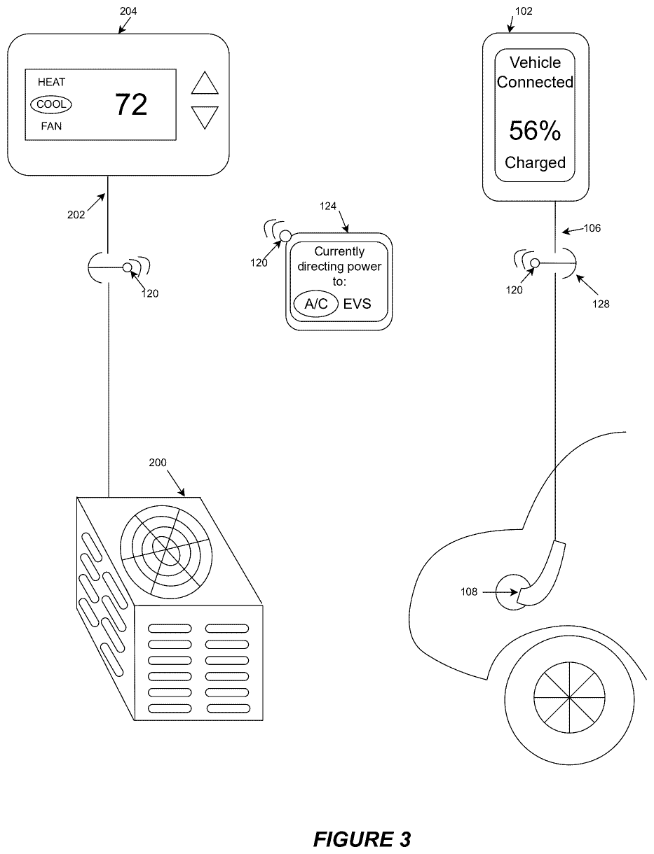

Generally, the interlock device, integrated interlock module, and electric vehicle supply define wired electrical connections to the load interrupter 126 and/or electric vehicle supply interrupter 128. However, as shown in FIG. 3, in the case that the existing load 200 is located far away from the electric vehicle supply, the interlock device and/or the integrated system can be implemented in a wireless variation wherein each of the load interrupter 126, the electric vehicle supply interrupter 128, and the load controller 204 include wireless transceivers 120 capable of transmitting and receiving signals.

Generally, the independent interlock device and integrated interlock module can define any combination of wired and wireless components. For example, an independent interlock device can include a first wireless transceiver configured to receive a control signal from a second wireless transceiver coupled to a wireless load interrupter. Further, the independent interlock can arrange proximally the electric vehicle supply and include a wired connection to the electric vehicle supply via a wired electric vehicle supply interrupter. In another implementation, the independent interlock can arrange proximally the existing load and define a wired connection to the control line of the existing load via a wired load interrupter. In this implementation, the independent interlock can receive and transmit signals to a wireless electric vehicle supply interrupter. Therefore, the independent interlock device and integrated interlock module can define any possible combination of wired and wireless connections to the electric vehicle supply and the existing load.

Each wireless transceiver 120 can thus enable remote monitoring and control of the engagement signal of the electric vehicle supply 102 and the control signal of the existing load 200 without requiring physical wiring between the interrupter and the controller. Design parameters for the wireless implementation include selecting robust wireless communication protocols (e.g., Zigbee, Bluetooth, or WiFi) and providing sufficient power to the transceiver to ensure reliable operation. This implementation solves the problem of integrating electric vehicle chargers with an existing load 200 without extensive wiring.

In one implementation, the interlock device can include a wireless monitoring system to detect engagement signals. For example, the electric vehicle supply interrupter 128 can include a wireless transceiver 120 coupled to the state line 106. The wireless transceiver 120 is configured to wirelessly transmit the engagement signal detected by the electric vehicle supply interrupter 128 to a second wireless transceiver 120 of the interlock device controller 130. The system 100 can communicate wirelessly on a frequency that does not interfere with other wireless devices in the household and has a range sufficient to span the distance between the state line 106 electric vehicle supply 102 and the interlock device controller 130. The wireless monitoring system can also include encryption to prevent unauthorized access and ensure data integrity.

### 9. Method of Load Management

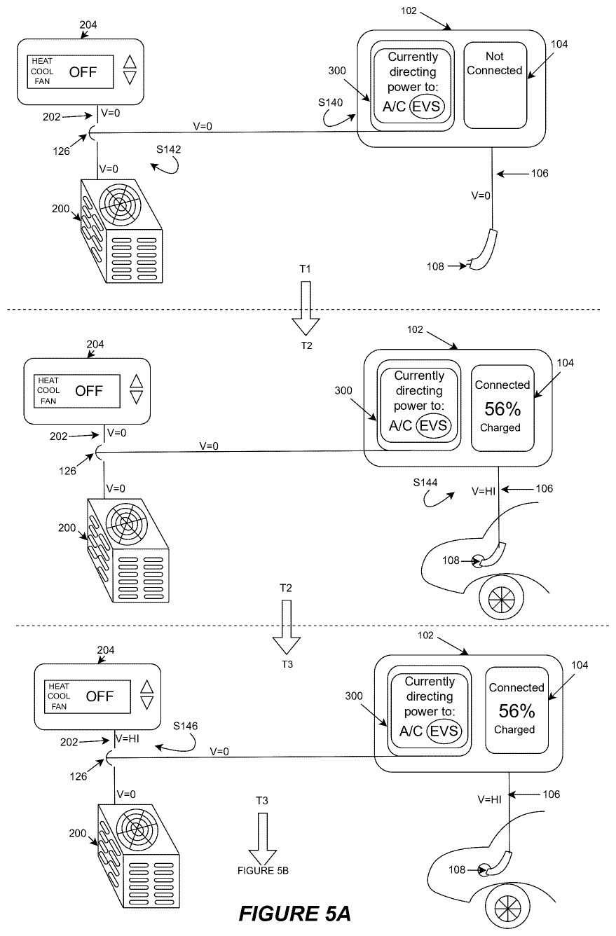

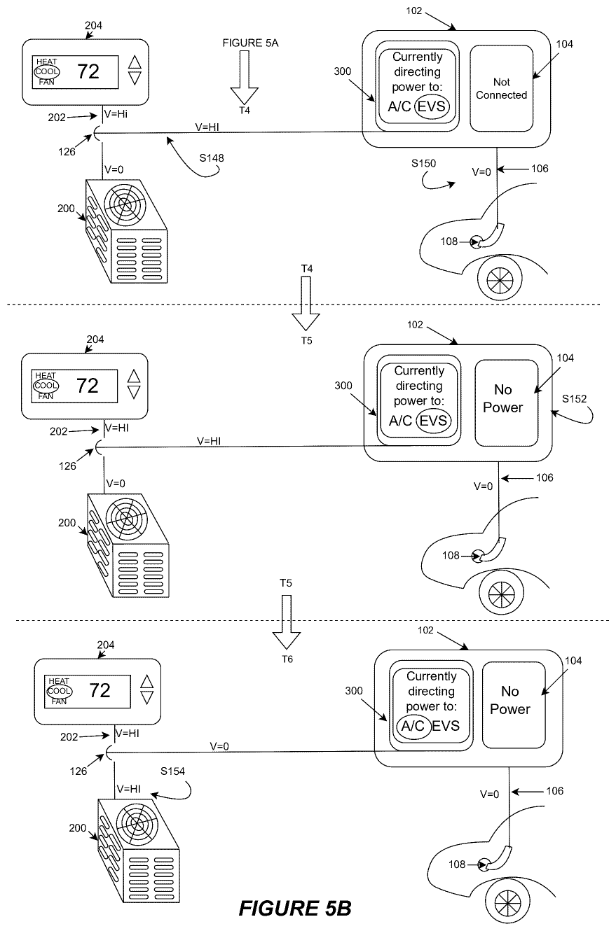

Generally, the method S100 is executed by the controller of the interlock device (as shown in FIGS. 4A and 4B) or the electric vehicle supply controller with an integrated interlock module (as shown in FIGS. 5A and 5B) to manage which load connected to the interlock device (e.g., an existing load 200 and an electric vehicle supply) receives power from the circuit and ensures no simultaneous connection of both loads to the circuit. The interlock module of the electric vehicle supply controller and/or the interlock device controller can be configured to execute the method S100. More specifically, the method S100 defines steps including: monitoring signals of the state line 106 of the electric vehicle supply 102 and the control line 202 of the existing load 200; and, in response to receiving a certain combination of signals, intercepting one or more signals and admitting one of the signals.

### 9.1 State Line Monitoring

Generally, the method S100 includes monitoring the state line 106 of the electric vehicle supply 102 to detect signals indicating an electrical connection between the electric vehicle and the electric vehicle supply in Step S140. The system 100 (e.g., including an electric vehicle supply 102 and interlock device as shown in FIG. 2) can continuously or periodically monitor (e.g., sample a signal from) the state line 106 to detect whether a vehicle is engaged or disengaged from the charging interface 108 of the electric vehicle supply. Thus, the system 100 can accurately detect the engagement signal and coordinate the power demands of the electric vehicle charger with existing loads, thereby eliminating the need to install new high-voltage circuits.

In one implementation, the interlock device is directly connected to the state line 106 via the electric vehicle supply interrupter 128, enabling real-time verification of engagement signals transmitted by the state line 106.

Additionally, the system 100 can include a smart monitoring system with data logging capabilities. In this implementation, the system 100 can include a smart monitoring system with a microcontroller and data storage connected to the state line 106 and configured to log the time and duration of each engagement event. The system 100 can also include a user interface, such as a mobile application or web portal, to access the logged data. The system 100 can be configured to handle high data volumes and provide secure data storage and data transmission. Thus, the system 100 can provide data to a user to inform charging schedule adjustments or for diagnostic purposes.

For an interlock module of the integrated variant described above, the interlock module monitors the state line via accessing state line signals processed by the electric vehicle supply controller. Therefore, the interlock module does not require an electric vehicle supply interrupter to monitor the signals of the state line of the electric vehicle supply.

### 9.2 Control Line Monitoring

Generally, the system 100 can monitor the control line 202 of the existing load 200 to detect activation signals from a load controller 204 of the existing load 200, indicating a demand for power to the existing load 200 in Step S142. More specifically, the system 100 is configured to monitor the control line 202 of the existing load 200, whereby the control line 202 is configured to transmit and receive a set of binary control signals. The set of binary control signals can include, for example, an activation signal configured to indicate power demanded by the existing load 200 (e.g., to power on the existing load 200) and a deactivation signal to power off the existing load 200.

The system 100 can also execute an implementation of the method S100 including continuous monitoring of the control line 202 to respond to changes in the state of the control line 202. The system 100 is configured in accordance with the specifications of the existing load's 200 control line 202.

The system 100 can monitor the control line S142 wirelessly, such as via a wireless transceiver 120 of the control line 202 interrupter configured to transmit and receive signals (e.g., indicating interception of a signal on the control line 202) to a remote interlock device controller 130, as described above with respect to the wireless implementation.

### 9.3 Signal Interception

Generally, the system 100 or interlock device 124 is configured to determine which load to direct power based on an ordering and/or prioritization of signals received from the control line 202 and the state line 106. More specifically, in response to receiving a first engagement signal via the charging interface 108 at a first time in Step S144 and receiving a first activation signal directed to the existing load 200 at a second time after the first time and concurrent with the first engagement signal in Step S146, the system 100: intercepts the first activation signal, and intercepts the first engagement signal. Thus, the system 100 or interlock device prevents simultaneous activation of both the existing load 200 and the electric vehicle supply and enables confirmation of cessation of power delivery before admitting the first activation signal toward the existing load.

For example, at a first time, an electric vehicle is connected to the electric vehicle supply 102 and begins charging. Thus, the electric vehicle supply controller 104 transmits a first engagement signal at the first time. Later, at a second time after the first time, while the electric vehicle supply 102 continues to charge the electric vehicle, a thermostat (the load controller 204) transmits an activation signal to an air conditioning compressor (the existing load 200) via the control line 202 to begin cooling. In response to receiving the activation signal to activate the compressor while the electric vehicle supply 102 charges the electric vehicle in Step S146, the system 100 intercepts (e.g., halts or otherwise stops) a continuous flow of the engagement signal indicating engagement of an electric vehicle to the charging interface 108, thereby indicating to electric vehicle supply 102 that the electric vehicle is no longer connected, therefore stopping power delivery to the charging interface 108 by the electric vehicle supply. The system 100 also intercepts (e.g., halts and/or prevents delivery of the signal to the compressor) the activation signal transmitted along the control line 202 to prevent the air conditioner compressor from activating while the circuit is still powering the electric vehicle supply.

Conversely, if the air conditioner compressor is on (e.g., the activation signal is being continuously transmitted) and an electric vehicle is plugged into the electric vehicle supply, the system 100 can intercept the signals as described above to prevent powering of both loads simultaneously. More specifically, in response to receiving the first activation signal directed to the existing load 200 at a third time and receiving a first engagement signal via the charging interface 108 at a fourth time after the third time and concurrent with the first activation signal, the system 100: intercepts the first engagement signal in Step S150. By intercepting the first engagement signal while the first activation signal is ongoing, the interlock device prevents the electric vehicle supply 102 from accessing power from the circuit while the air conditioner compressor is currently in use and drawing power from the circuit. Alternatively, if the charging is currently prioritized over the existing load, the system 100 or interlock device 124 can intercept both the first activation signal and the first engagement signal to confirm cessation of power delivery to the existing load 200 prior to admitting the first engagement signal toward the electric vehicle supply 102.

Signal interception is a basic action of the method S100, including physically or logically interrupting the engagement signal and the activation signal. The interlock device system can include relays or switches that can be activated to interrupt these signals and prevent power from being delivered to both the electric vehicle supply 102 and the existing load 200. Design parameters for this action include: reliability of the interception mechanisms and latency of the interception mechanisms to prevent overlap in power delivery to the electric vehicle supply 102 and the existing load 200. The system 100 can also include fail-safes to prevent the interruption of the engagement signal and the activation signal from affecting the operation of other devices connected to the system 100.

In one implementation, an existing load can connect to a set of control lines transmitting a set of binary signals for activating and deactivating the load. For example, an existing load can include two control lines via which signals are transmitted to the load to activate a specific mode of the existing load 200, such as a low power control line and a high power control line. The existing load 200 can therefore activate a high-power mode, such as when both control lines are powered, and activate a low mode, such as when only the low power control line is powered. The load interrupter can therefore interrupt multiple control lines. Further, the interlock device can intercept signals on multiple control lines, allowing the interlock to manage loads with sets of control lines and multiple modes and/or control signals.

### 9.4 Confirming Cessation in Power Delivery

Generally, after intercepting both the activation signal and the engagement signal, the system 100 or interlock device 124 confirms that power has ceased delivering to one load before allowing the other to activate in Step S152. The system 100 or the interlock device 124 can confirm cessation of power delivery by detecting events corresponding to greater than a threshold likelihood of the cessation of power delivery. For example, the system 100 or the interlock device 124 can directly sample a power line of the existing load 200 and/or the electric vehicle supply or wait a threshold time after intercepting the signal that corresponds with the threshold likelihood of cessation in power delivery to the existing load 200 and/or the electric vehicle supply.

For example, after the thermostat sends an activation signal to the compressor while the electric vehicle supply 102 is charging a vehicle, the system 100 or the interlock device 124 intercepts the engagement signal from the electric vehicle supply 102 (e.g., electrically indicating that the vehicle is now unplugged and power delivery to the charging interface 108 can stop). The system 100 or interlock device 124 then identifies a cessation in power delivery to the electric vehicle supply 102, such as via waiting for a threshold length of time after intercepting the first engagement signal, whereby the threshold length of time based on a known (i.e., calibrated) length of time for the cessation in power delivered to the charging interface 108 after an absence of engagement signal in Step S152.

In one implementation, the system 100 identifies cessation of power delivery to the electric vehicle supply 102 by: monitoring, via the state line 106, an electric power state of the electric vehicle supply; and receiving an off state signal of the electric power state indicating cessation of power delivery to the charging interface 108.

In another implementation, the system 100 is additionally configured to identify cessation of power delivery to the existing load 200 via waiting a threshold length of time for power to leave the existing load 200 system after sending a deactivation signal or absence of an activation signal. The system 100 can also sample a power delivery line of the existing load 200 to determine a state of the existing load 200 and detect if the existing load 200 is in a powered-off state and no longer demands power from the circuit.

9.5 Admitting Activation and/or Engagement Signal

Generally, in response to confirming cessation of power delivery to one of the loads, the system 100 admits an activation signal or engagement signal to power the opposite load in Step S154. For example, in response to confirming cessation of power delivery to the charging interface 108 of the electric vehicle supply, the system 100 admits an activation signal via the control line 202 to power on the existing load 200. Admission of the activation signal may include allowing the activating signal initially intercepted by the control line interrupter to propagate past the interrupter to a receiver of the existing load 200, thereby powering on the load. Alternatively, the system 100 or the interlock device 124 can admit the activation signal by mimicking or retransmitting the activation signal toward the existing load 200 along the control line.

The method S100 includes, in response to confirming cessation of power delivery to the electric vehicle supply, admitting the activation signal to the existing load 200 in Step S154. More specifically, the method S100 includes admitting the intercepted activation signal to the existing load 200 (e.g., an air conditioner) to activate the existing load 200 without overloading the electrical circuit. Thus, the method S100 includes coordinating activation of the existing load 200 with cessation of power delivery to the electric vehicle by the electric vehicle supply 102 to prevent circuit overloads. The method S100 includes: admitting the activation signal to the existing load 200 via the control line. Thus, the existing load 200 receives the activation signal and operates in response to the activation signal with a short delay to confirm cessation of power delivery by the electric vehicle supply to the electric vehicle, thereby preventing significant disruption in the operation of the existing load 200 by the load controller.

### 9.6 Prioritization

Generally, the system 100 or the interlock device 124 can provide or communicate with a user interface allowing a user of the system 100 or the interlock device 124 to select a load (e.g., the existing load or the electric vehicle supply) to prioritize when an activation signal and an engagement signal are simultaneously detected. For example, the interlock device can include a switch that a user can toggle to select prioritization of the electric vehicle supply or the existing load 200. More specifically, the system 100 or interlock device 124 can sample a prioritization state (e.g., a position of a physical switch or a value stored in local memory) to determine which of the electric vehicle supply 102 and the existing load 200 is prioritized for power delivery. Thus, the system 100 or interlock device 124 can intercept and admit signals to prioritize loads based on the prioritization signal.

In one implementation, the system 100 or interlock device 124 can dynamically: prioritize a load to deliver power to based on real-time conditions, user preferences, time of day, and/or current power demand and generate a prioritization signal. The system 100 or interlock device 124 can interface with home automation systems to enable homeowners to set preferences via a user interface, thereby improving energy efficiency and system performance.

In another implementation, the method S100 includes determining user prioritization preferences as an auxiliary action concurrent with sampling prioritization signals. This action includes collecting data from the user regarding the user's preferred prioritization between the electric vehicle supply 102 and the existing load 200. A user interface, such as a mobile application or web-based user interface, can be configured to receive user preferences. The system 100 or interlock device 124 can also store the user preferences and update the user preferences in real-time as the user modifies the user preferences. The system 100 or interlock device 124 can provide feedback to the user that the user preferences have been recorded and applied to increase the user's confidence in the system 100 or interlock device 124 and the user's control over the power distribution between the electric vehicle supply 102 and existing loads 200.

In yet another implementation, the system 100 or the interlock device 124 can execute time-of-day-based prioritization that further modifies the load prioritization process by prioritizing the load based on the time of day. For example, the system 100 can prioritize the electric vehicle supply 102 during off-peak hours when the local time-of-use electricity rate is lower and prioritize the existing load 200 during peak hours. This implementation requires the interlock device system to be loaded with local time-of-use rate schedules and to include a real-time clock to determine the time of day.

### 10. Additional Considerations

As a person skilled in the art will recognize from the previous detailed description and from the figures and claims, modifications and changes can be made to the embodiments of the invention without departing from the scope of this invention as defined in the following claims.

We claim:

1. A system for charging an electric vehicle comprising:
an electric vehicle supply comprising:
an electric vehicle supply controller comprising an engagement input;
a charging interface comprising an engagement output; and
a state line communicatively coupling the electric vehicle supply controller to the charging interface and configured to indicate engagement between the charging interface and the electric vehicle supply controller;
an interlock device:
interrupting an existing control line between a control output of a load controller of the existing load and a control input of the existing load;
communicatively coupled to the control input of the existing load;
communicatively coupled to the control output of the load controller of the existing load;
configured to, in response to receiving a first engagement signal via the charging interface at a first time and receiving a first activation signal directed to the existing load at a second time after the first time and concurrent with the first engagement signal:
intercept the first activation signal;
intercept the first engagement signal; and
in response to confirming a cessation in power delivered to the charging interface, admit the first activation signal to the existing load.

2. The system of claim 1, wherein the electric vehicle supply controller is further configured to, in response to receiving the first activation signal directed to the existing load at a third time and receiving a first engagement signal via the charging interface at a fourth time after the third time and concurrent with the first activation signal:
intercept the first engagement signal;
intercept the first activation signal; and
in response to confirming a cessation in power delivered to the existing load, admit the first engagement signal to the charging interface.

3. The system of claim 1, wherein the electric vehicle supply controller is configured to identify the cessation in power delivered to the charging interface by:
waiting for a threshold length of time after intercepting the first engagement signal, the threshold length of time based on a known length of time for the cessation in power delivered to the charging interface after an absence of engagement signal.

4. The system of claim 1, wherein the electric vehicle supply controller is configured to identify the cessation in power delivered to the charging interface by:
monitoring an electric power state of the electric vehicle supply; and
receiving an off state signal of the electric power state indicating cessation of power delivery to the charging interface.

5. The system of claim 1, wherein the interlock device:
interrupts the state line of the electric vehicle supply;
communicatively couples to the engagement output of the charging interface; and
communicatively couples to the engagement input of the electric vehicle supply controller.

6. The system of claim 1, wherein the electric vehicle supply controller is integrated with the electric vehicle supply.

7. The system of claim 1, wherein the electric vehicle supply controller is a separate device from the electrical vehicle supply.

8. The system of claim 1, wherein:
the existing load is electrically coupled to an existing circuit of an electrical panel; and
the electrical vehicle supply is electrically coupled to the existing circuit of the electrical panel.

9. The system of claim 1, wherein:
the interlock device comprises:
a load interrupter:
defining an electrical connection to the control line of the existing load; and
configured to interrupt signals admitted and received by the existing load via the control line;
an electric vehicle supply interrupter:
defining an electrical connection to the state line of the electric vehicle supply controller; and
configured to interrupt signals admitted and received by the electric vehicle supply controller via the state line;
an interlock device controller configured to:
a monitor the control line via the load interrupter; and
monitor the state line of the electric vehicle supply controller via the electric vehicle supply interrupter.

10. The system of claim 9, wherein:
the load interrupter:
arranges within a load interrupter housing proximal to the existing load; and
further comprises a first wireless transceiver;
the electric vehicle supply interrupter:
arranges within an electric vehicle supply interrupter housing proximal to the electric vehicle supply; and
further comprises a second wireless transceiver;
the interlock device controller:
arranges within an interlock device controller housing remote to the load interrupter housing and the electric vehicle supply interrupter housing; and
comprises an interlock device controller transceiver configured to:
transmit signals to the first wireless transceiver and the second wireless transceiver; and
receive signals from the first wireless transceiver and the second wireless transceiver.

11. A method for charging an electric vehicle comprising:
monitoring a state line of an electric vehicle supply, the state line configured to transmit and receive engagement signals indicating electrical connection between an electric vehicle and the electric vehicle supply;
monitoring a control line of an existing load, the control line configured to transmit and receive a set of binary control signals; and
in response to:
receiving a first engagement signal via the state line of the electric vehicle supply at a first time; and
receiving a first activation signal directed to the existing load via the control line at a second time after the first time and concurrent with the first engagement signal:
intercepting the first activation signal;
intercepting the first engagement signal; and
in response to confirming a cessation in power delivered to the charging interface, admitting the first activation signal to the existing load.

12. The method of claim 11, further comprising:
sampling a prioritization signal; and
in response to the prioritization signal indicating the electric vehicle supply:
intercepting the first engagement signal; and
in response to receiving the first activation signal directed to the existing load via the control line at the second time after the first time and concurrent with the first engagement signal:
blocking the the first activation signal to prevent reception of the first activation signal by a load controller of the existing load; and
admitting the first engagement signal to the electric vehicle supply controller.

13. The method of claim 11, further comprising:
sampling a prioritization signal; and
in response to the prioritization signal indicating the electric vehicle supply:
intercepting the first activation signal; and
receiving a first engagement signal via the state line of the electric vehicle supply concurrent with the first activation signal:
blocking the first engagement signal to prevent reception of the first engagement signal by an electric vehicle supply controller of the electric vehicle supply; and
admitting the first activation signal to a load controller of the existing load.

14. The method of claim 11, wherein confirming the cessation in power delivered to the charging interface, comprises:
waiting for a threshold length of time after intercepting the first engagement signal, the threshold length of time based on a decay time of power delivery to the charging interface.

15. The method of claim 11, wherein confirming the cessation in power delivered to the charging interface comprises:
monitoring an electric power state of the electric vehicle supply; and
detecting a deactivated state of the electric vehicle supply indicating cessation of power delivery to the charging interface.

16. An interlock device for charging an electric vehicle:
interrupting an existing control line between a control output of a load controller of an existing load and a control input of the existing load;
communicatively coupled to the control input of the existing load;
communicatively coupled to the control output of the load controller of the existing load;
interrupting a state line of the electric vehicle supply, the state line communicatively coupling an electric vehicle supply to a charging interface and configured to indicate engagement between the charging interface and the electric vehicle supply;
communicatively coupled to an engagement output of the charging interface;
communicatively coupled to the engagement input of the electric vehicle supply; and
configured to, in response to receiving a first engagement signal via the charging interface at a first time and receiving a first activation signal directed to the existing load at a second time after the first time and concurrent with the first engagement signal:
intercept the first activation signal;
intercept the first engagement signal; and
in response to confirming a cessation in power delivered to the charging interface, admit the first activation signal to the existing load.

17. The interlock device of claim 16, wherein the interlock device is configured to identify the cessation in power delivered to the charging interface by:
waiting for a threshold length of time after intercepting the first engagement signal, the threshold length of time based on a known length of time for the cessation in power delivered to the charging interface after an absence of engagement signal.

18. The interlock device of claim 16, wherein the interlock device is configured to identify the cessation in power delivered to the charging interface by:
monitoring an electric power state of the electric vehicle supply; and
receiving an off state signal of the electric power state indicating cessation of power delivery to the charging interface.

19. The system of claim 16, wherein:
the interlock device comprises:
a load interrupter:
defining an electrical connection to the control line of the existing load; and
configured to interrupt signals transmitted and received by the existing load via the control line;
an electric vehicle supply interrupter:
defining an electrical connection to the state line of the electric vehicle supply controller; and
configured to interrupt signals transmitted and received by the electric vehicle supply controller via the state line;
an interlock device controller configured to:
a monitor the control line via the load interrupter; and
monitor the state line of the electric vehicle supply controller via the electric vehicle supply interrupter.

20. The interlock device of claim 19, wherein:
the load interrupter:
arranged within a load interrupter housing proximal to the existing load; and
further comprising a first wireless transceiver;
the electric vehicle supply interrupter:
arranged within an electric vehicle supply interrupter housing proximal to the electric vehicle supply; and
further comprising a second wireless transceiver;
the interlock device controller:
arranged within an interlock device controller housing remote to the load interrupter housing and the electric vehicle supply interrupter housing; and
comprising an interlock device controller transceiver configured to:
a transmit signals to the first wireless transceiver and the second wireless transceiver; and
a receive signals from the first wireless transceiver and the second wireless transceiver.
